(19) United States
(12) Patent Application Publication
(10) Pub. No.: US 2024/0233394 A1
(43) Pub. Date: Jul. 11, 2024

(54) REAL-TIME CHARGING POINT AVAILIBILTY AND PLANNING

(71) Applicant: FORD GLOBAL TECHNOLOGIES, LLC, Dearborn, MI (US)

(72) Inventors: Tyler James-Ray KALDOBSKY, Canton, MI (US); Anthony FAKHOURI, Rochester, MI (US); Robert David HANCASKY, Warren, MI (US); Gary LEPIDI, Riverview, MI (US)

(21) Appl. No.: 18/150,500

(22) Filed: Jan. 5, 2023

(51) Int. Cl. G06V 20/58; G08G 1/00; H04N 7/18

(52) U.S. Cl. CPC G06V 20/58; G08G 1/20; H04N 7/183; G06V 2201/08

(57) ABSTRACT

A system receives an image identified as related to a charging location and including at least one viewpoint of the charging point and analyzes the image to determine if the charging point is currently in use based at least in part on the presence of a vehicle at the charging point in the image. The system determines projected usage time of a charging point determined to be in use, based on at least one characteristic of the vehicle and updates a usage set indicating real-time usage of the charging point based on the projected usage time.

### TECHNICAL FIELD

The illustrative embodiments generally relate to real-time charging point availability and planning.

### BACKGROUND

Electric and hybrid (gas and electric) vehicles have made significant inroads in adoption in the last decade, and many original equipment manufacturers (OEMs) are turning their efforts to increasing the production and deployment of these vehicles. Just as with the prior internal combustion engine (ICE) vehicles, however, these new vehicles also require forms of fuel and hence, refueling.

Refueling for electric vehicles is known as recharging and constitutes connecting the vehicle to a power providing source while a vehicle battery uses the source to recharge. Many vehicles can charge at an owner's home, using conventional power hookups, and this provides a level of convenience not experienced with traditional ICE vehicles.

If the driver travels more than half an available range however (the difference being the power needed to return home), then the driver will definitionally need to at least partially recharge a vehicle before returning home. While there are a massive number of gas stations available on public roads, there are a far more limited number of charging stations. This can lead to users having to travel some distance off-route in order to find a recharging point.

Also, unlike filling up ICE vehicle tanks, recharging a vehicle can often take more than a few minutes, depending on how much power is needed to complete a journey. Many users need more than a minor charge to complete a journey, which can lead to them waiting 10-30 minutes, or more, to obtain desired charge. This means that charger cannot be used by others for the duration of the recharge, and so a vehicle arriving at a full charging station may have to wait some amount of time before a charger is available.

The stations may also lack adequate queuing instructions, which means a user also may have to guess at which charging point will open next and get into a line that may not be the best choice. If stations do not provide for linear queuing, a user may be stuck with their choice. To accommodate at least this aspect of the delay, many stations allow for reservations, which is good for reserving a “next available” spot, but problematic for a user on low charge who pulls up hoping to charge next—even if there are not a significant number of waiting vehicles present, spots may be reserved for hours yet to come.

As electric vehicles grow more prevalent, the financial incentives to provide charging will increase, and more and more stations should become available. Even under such a model, however, users would likely prefer to know that they have a secured space in advance of arrival.

### SUMMARY

In a first illustrative embodiment, a system includes one or more processors configured to receive an image identified as related to a charging location and including at least one viewpoint of the charging point and analyze the image to determine if the charging point is currently in use based at least in part on the presence of a vehicle at the charging point in the image. The one or more processors are further configured to determine projected usage time of a charging point determined to be in use, based on at least one characteristic of the vehicle and update a usage set indicating real-time usage of the charging point based on the projected usage time.

In a second illustrative embodiment, a vehicle includes one or more processors configured to determine that a current vehicle location corresponds to a predefined image capture location included in an image capture request, and determine that the vehicle includes at least one camera having a field-of-view encompassing directionally for imaging identified in the image capture request. The one or more processors are further configured to, responsive to both the current vehicle location corresponding to the image capture location and the vehicle including the at least one camera, automatically capturing an image using the at least one camera and automatically sending the image to a backend that issued the image capture request.

In a third illustrative embodiment, a method includes receiving at least one image from a vehicle that captured the image, the image sent as indicative of a current use status of a charging point and including a location of the vehicle when the image was captured. The method also includes analyzing the image to determine whether there is at least one visual impediment present in the image and, responsive to determining a visual impediment is present, both updating the location as an obstructed location in a dataset and updating an image capture request to one or more other vehicles to remove the location from a set of locations at which image capture is requested.

### BRIEF DESCRIPTION OF THE DRAWINGS

FIG. 1A shows an illustrative example of a charging station with charging and passing vehicles, as well as illustrative example of a system for gathering and analyzing charging point data;

FIG. 1B shows a further example of a cloud backend for analyzing data captured by vehicles and/or provided by infrastructure or charging vehicles;

FIG. 2 shows an illustrative process for automatic image capture;

FIG. 3 shows an illustrative process for image and station usage analysis;

FIG. 4A shows an illustrative reporting process; and

FIG. 4B shows an illustrative charging report reception and utilization process.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Because many OEMs are not in direct control of charging stations, just as they are not in direct control of gas stations, it can be difficult to keep an accurate accounting of where charging is available and when. Drivers would like to know where they can actually charge, and/or how long wait times will be, as charging can play a role in the duration of a longer journey, and side-trips to charging stations will be better received if the time-effect on the driver is mitigated.

For example, a driver would likely rather drive an extra 10 miles, taking an extra 15 minutes in each direction, to charge immediately, than to wait for an hour at a more conveniently located charging station. A nice aspect of electric vehicles is that travel is relatively cheap compared to ICE vehicles, and so time becomes the controlling factor. Thus, a 30-minute round trip journey (plus charge time) is more effective on many fronts than an hour-long wait plus charge time.

The illustrative embodiments allow for capture and analysis of the real-time state of charging points at charging stations, allowing for better planning and better recommendations for charging point usage and availability. While it is presumably possible for all charging stations and/or vehicles to report usage, and while that is not outside of the scope of this disclosure, there are many instances where such reporting may be difficult to obtain—for example, stations that do not participate with an OEM for reporting, other brand OEM vehicles only reporting to their respective OEMs, loss of connectivity, etc.

At the same time, many vehicles have comprehensive external camera systems that can capture images and see a good distance in many direction from the vehicle. Since those cameras are frequently available for usage, especially spot usage, and because they tend to have known viewing angles from a given vehicle, it is reasonable to use vehicles, passing charging points, to capture images of the charging points or stations to determine present usage.

The presence or absence of a vehicle at a charging point is only part of the story however, since some vehicles may require longer periods of charge than others and because spaces can be reserved in advance. Nonetheless, this image data can be used to model predicted outcomes—such as projected charge times based on make and model. Consecutive data points showing a vehicle can be used to update statistical models, based on lapsed charging time. In some instances, visible fuel indicators show the current state of charge, bettering modeling. Knowledge about behavior patterns—e.g., in certain areas, or at night, or in the cold, etc., people may only partially charge vehicles more or less frequently than under other conditions—can also help better modeling and prediction.

Absolute knowledge of reservations would be useful, except that some stations may not use reservations and in other instances, reservations may be skipped or overextended. Further, there may be incentives to move away from reservation-based systems if there is significant demand, because people will be incentivized to over-reserve spaces. By knowing, via imaging, the actual reality of the present situation at the station, many of these possible issues can be overcome. This data can be married with additional data in fusion to produce increased outcomes, but barring actual reporting from stations and vehicles on-site, at every site, there are not a significant number of alternatives to a real-time snapshot of the use or non-use of a charging point. And, unlike the reporting, the snapshot can leverage technology already passing by the station regularly without requiring any agreement with the station owner and/or without any reliance on the accuracy of information reporting.

As images are gathered and processed, better recognition can be made of the locations and directions of cameras most suitable to capture images of a certain charging point or station. That is, initially any vehicle with a presumed view of the station can capture images, but trees, signs and other impediments may reveal that certain locations are flawed or unsuitable. Vehicles can skip imaging at those locations, or based on certain headings, cross-traffic, etc. This will lead to fewer, more accurate images and reduce bandwidth usage while increasing overall quality and usefulness of images.

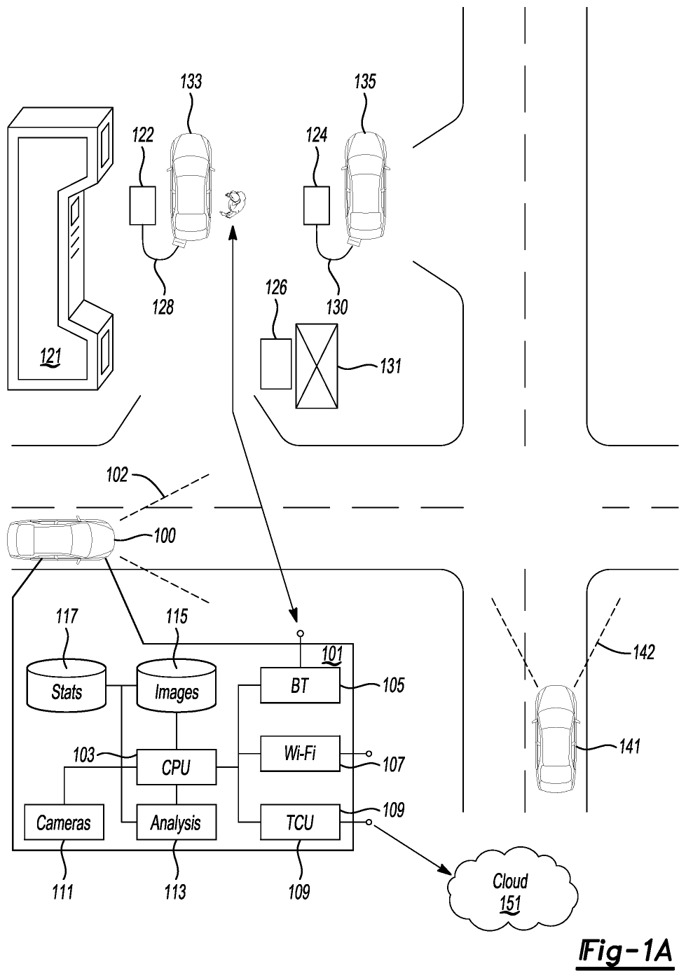

FIG. 1A shows an illustrative example of a charging station with charging and passing vehicles, as well as illustrative example of a system for gathering and analyzing charging point data. In this example, one or more passing vehicles 100, 141 may have views of a charging station 121 and attendant charging points 122, 124, 126.

Each vehicle 100 may include an onboard computing system with one or more cameras 111 capable of imaging various external viewpoints from a vehicle 100. While the present example shows the field of view 102 as forward, it is appreciated that these cameras could be side or rearward facing and could image the station from any appropriate perspective based on where the vehicle 100 is located at the time of image capture. For example, the best view of the station 121 from the perspective of vehicle 100 may be from a rearward camera as the vehicle 100 passes the intersection.

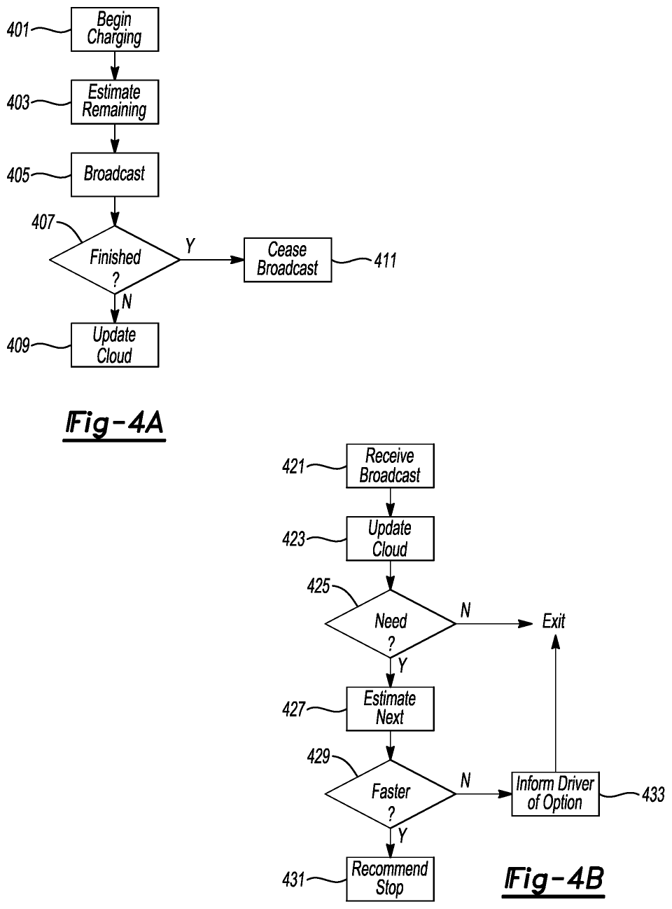

The computing system may include one or more processors 103 and a variety of communication mediums. These can include, for example, BLUETOOTH transceiver 105, Wi-Fi transceiver 107 and a telematics control unit (TCU) 109. The BLUETOOTH transceiver 105 may be used for local communication with charging vehicles, as discussed herein with respect to FIGS. 4A and 4B. Wi-Fi transceiver 107 could be used to access data from a station network or local infrastructure. TCU 109 can be used for long-range communication with the cloud 151, which can include uploading images for analysis and receipt of station-usage data or recommendations for charging.

The vehicle 100 may have the capability for complete or limited onboard analysis of images 113, which in this example can include accessing a database of vehicles 115 and accessing both vehicle and charging statistics 117.

The database of vehicles may include makes, models and charging times for a variety of vehicles, and may be referenced based on image processing to identify a vehicle from the database. The statistics database 117 may include charging times based on various contexts (weather, time of day, for a given region etc.) as well as common charging times for a given station. Fused together, this information can be used to determine a reasonable estimation of how long a given vehicle is going to continue charging.

Even if a charging status indicator, such as an external display, is visible in the image, the status is not always clear and there are no assurances the driver will charge to a full charge in any event. Thus, even when the charging indicator is visible in an image, some level of modeling may be useful to refine results.

Users can be shown results as statistical outcomes such as “there is a 75% chance a bay will be open when you arrive,” or in the form of weight-affected time values such as “there is an expected 23 minute wait” (where 23 minutes is the statistically weighted average expected wait time) or in any other reasonable manner. Some users may prefer to gamble on an open station with a low likelihood of availability, but for which spots are open now, whereas other users may prefer to go with the lower projected wait time, even if it guarantees some level of waiting.

As each vehicle 100, 141 passes a point where a known field of view 102, 142 of a respective vehicle camera encompasses at least one charging point 122, 124, 126, the vehicle can be instructed to automatically capture one or more images of the charging point(s) for analysis and/or upload. Usable images, such as those that show a vehicle fully in the space or sufficiently to identify it's make and model, or license plate, or other useful identifier, such as a charging indicator, can be flagged with respect to the location and capturing vehicle. Then, other vehicles with comparable fields of view passing that location can obtain pictures. Other variables that might play into the usefulness of images can temporary obstructions (high traffic), permanent obstructions, time of day, weather, etc.

A plan to image charging points at a station can begin with a wide geofence around the station and that geofence can be refined to locations where the images are most useful, based on iterative feedback from collected images, so that the higher quality and usefulness images can be more selectively obtained.

The vehicle 100 may have the capability to process images to identify certain characteristics, such as make and model, charging status based on visible charging meter, etc. Depending on how fixed the paradigms are, such as whether each vehicle has uniform charging indicators from a given OEM, the processing may make more sense to be done onboard or in the cloud. Doing the analysis onboard reduces image transmission, but constantly changing variables may make the work more suitable for the cloud, which can have continually updated datasets without having to push dataset updates to millions of vehicles.

FIG. 1B shows a further example of a cloud backend for analyzing data captured by vehicles and/or provided by infrastructure or charging vehicles. In this example, the cloud 151 receives a number of possible inputs, such as data from a vehicle through the TCU 109, data from a charging vehicle 133, and data from a station 121 or charging point.

Vehicles 100 can report observational data at 109, which can be useful because it shows the current reality of the charging point or station. Vehicles that are charging 133 can report state of charge (SoC) such as fullness, charge speed, projected time to full, etc. Stations 121 can report reservation information, current usages, etc. Users may not report intended charge state obtainment, such as “I will charge this vehicle to 50%” or “to a range of 200 miles” unless that is an option in the vehicle or on the charging point.

If users tend to behave in a time-preserving manner, intending to top off vehicles at home, then it may be the case that users will elect to charge the vehicle to the minimum charge necessary (plus a threshold) to reach home, given whatever travel remains. An option to do this could be provided in the vehicle—wherein a route engine indicates the expected charge necessary to reach home and the user elects to, for example, charge to that level +10%. The vehicle could communicate this information to both the charging point and the backend, and then there would be a reasonable metric for measuring duration of the charge.

In other examples, a user may elect, via the vehicle or charging point, to “charge for 15 minutes,” or “charge to 50%.” The former would give a definitive usage time and the latter allows for a calculation since the current SoC and a charge speed would likely be known. Either could be reported to the backend for a reasonable estimation of planned usage time for the given charging point.

Similarly, stations 121 could report this information to the extent available, and/or could report reservations and current reservation duration, to provide insight into open charging windows. This data may be subject to manipulation, however, such as by a station wanting to draw in traffic and under-reporting usage. Other stations may want some concession for providing this information, and so there could be a fee associated with gathering this information.

When vehicles capture images that are usefully indicative of charging, there is limited overhead and a good assurance of the validity of the data. Moreover, this allows for immediate information gathering on any new charging station without having to negotiate any relationship with a station owner, or relying on a given OEMs own vehicles to be using the station to self-report. That is, if OEM1 only reported to OEM1, then those vehicles would not provide useful information, while charging, to any other entity. But viewing those vehicles could provide insight for OEM2 in terms of providing useful information to OEM2's customers.

The cloud 151 may include a gateway 153 for routing incoming information and outgoing information, which in this case could include station status updates and recommendations for users, as well as planning reservations.

For data requiring processing, such as images, the gateway 153 could route that data to an image processing center 155, which can include vehicle data 157 and statistical data 159. Statistical data can include, for example, models on behavior with regards to certain owner types, demographics, regions, times of day, weather conditions, etc. For example, it may be observed that users charging just before rush hour tend to charge either very little (in an attempt to beat the traffic) or significantly (in an intent to wait-out the traffic). Vehicles with over 50% SoC may be charged briefly, vehicles with less than 10% SoC may be charged fully. So information indicating time of day and current SoC (from a charge meter) could be used to sort the charging vehicles into the likely two groups.

Stations may also have an incentive to provide this information to passing vehicles, and so charging points may, based on feedback from a vehicle, indicate a current SoC in a visible manner. This would also be a generally useful tactic so that passing humans could observe whether a spot was likely to open up soon. An additional indicator might indicate whether the spot was reserved for a next-customer or was going to open up when the current user departed.

Image processing results can be used to update a locations dataset 161, which can include refinements to geofences for image capture. These refinements may be pushed to vehicles that have routes which are passing charging points and/or vehicles which frequently travel within a proximity to a known charging point.

Image processing results indicating a make, model, SoC, context and other information may be sent to analysis 163, which can perform an estimate of remaining charging time for identified vehicles. This may be a best guess, but with refinements based on behavior and other variables, as explained, it may be possible to extract a high probability remaining charging time.

Vehicle data reports from self-reporting vehicles can be stored in a self-reporting dataset 163, which can be used to track known charging point usage. Station data reported can be similarly stored in a station dataset 167, which can include planned reservations, open slots, current usages, etc. A planning process 169 can draw from the analysis results, self-reporting data sets and station datasets to determine where a given user in need of a charge would be best served in traveling. This information can be reported as a recommendation, a set of projected usage statistics, average expected wait times at multiple points, etc.

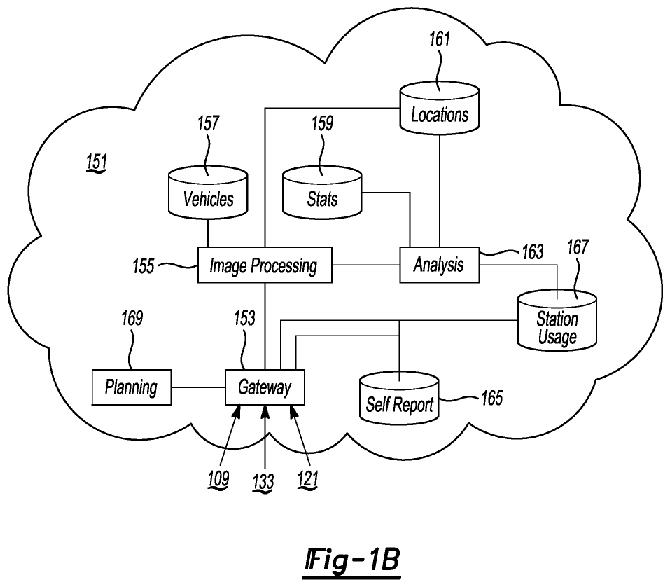

FIG. 2 shows an illustrative process for automatic image capture. This is a process wherein a given vehicle, such as a personal vehicle that belongs to a fleet of a particular OEM (belongs in the sense that the OEM made the vehicle), can be tasked with data gathering. OEMs can offer a value exchange for this information, or simply cover the price of data usage. The value exchange may be as simple as the fact that the user benefits from all other users collecting comparable data.

When the vehicle 100 is within a defined geofence at 201 (or other location-based or suitable trigger), the process may determine if the vehicle has the correct sensors (e.g., a camera at a preferred height or location with a necessary field of view) at 203. Different vehicles may provide different perspectives at different locations based on trim level and camera placement. It may initially be wise to have all vehicles with any imaging capability capture data, but this data can be used to quickly refine what data is most useful from what cameras at what locations and having what fields of view. At that point, the OEM may elect to get more specific in requests for automatic data gathering to reduce transmission overhead. A request may specify an area to be captured and a given vehicle may be able to determine, based on its own orientation (e.g., heading), whether the fields of view of one or more of that vehicle's cameras encompass the specified directionality, i.e., whether at least one camera can see the area of interest.

If the vehicle has adequate sensors (if that determination is even made) at 203, then the process has another elective consideration as to whether or not a temporary obstruction is present at 205. In this example, it is assumed that prior permanent obstructions have been identified and the locations have been tied to non-obstructed views, but that permanent obstruction determination could also be a part of this determination. If the camera does not register a passing vehicle, traffic blocking a view, or other temporary obstruction such as heavy snow, then the process can proceed to 207, which in this case is a heading determination.

Since a geofence will likely not, at least always, be locked to a given specific point, but rather encompass a range of points, vehicles heading in multiple directions may be passing through the fence. Vehicles whose heading places their cameras without a view of the station at 207 may be determined unsuitable for image capture. If these and other optional variables are met at 207, then the process can instruct the vehicle 100 to obtain an image of the station and/or charging points at 209 and pass that image to onboard or cloud processing at 211. The vehicle 100 may at least do pre-processing prior to passing the image to the cloud, to ensure the image has characteristics identified as suitable for final processing in the cloud, such as not being obstructed, blurred, having at least one visible charging point, etc.

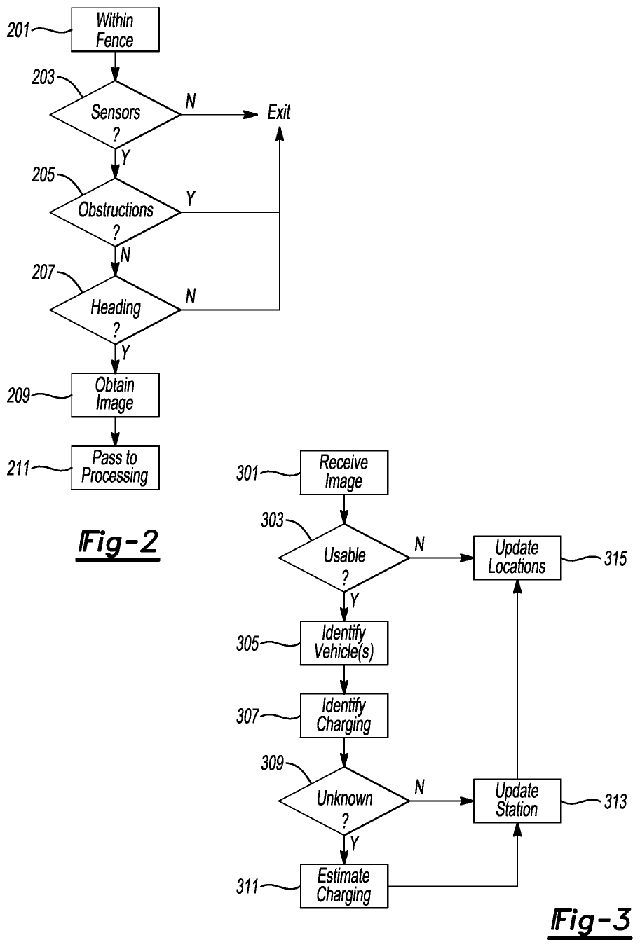

FIG. 3 shows an illustrative process for image and station usage analysis. In this example, the process receives an image captured by a vehicle at 301. Images may also include video and the process may be configured to extract usable data from video as well as static images.

If the image has usable characteristics at 303 (for example, without limitation, view of a charging vehicle or empty space, view of a charging point, view of a license plate, view of an SoC indicator, etc.) then the process may attempt to identify any vehicle visible in the image at 305.

If the image shows, for example, a permanent or temporary obstruction and no usable views at 303, this information may be used to update a locations dataset at 315, to indicate that a vehicle with the characteristics of the image-capturing vehicle had permanent or temporary difficulty obtaining a usable image at the location where the image was captured. Other vehicles with comparable cameras may then not be instructed to gather comparable images under comparable conditions.

If the process needs to identify vehicles based on make and model at 305, it can use a dataset of vehicle views to do so. This can help identify max charging times, whether the vehicle can fast charge, what the vehicle range generally is, etc. Even vehicle range may be relevant, because if a vehicle has a high range it may tend to charge for shorter durations if highly efficient, or, conversely, may take a much longer time to charge if it has a larger battery capacity to enable this range.

If any of the vehicles are showing visible charging indicators that show a current SoC, that information can be used at 307 to estimate remaining charge time. It still may be unknown whether the customer is going to fully charge, but at least a ceiling can be placed on maximum charge time remaining and conclusions may be drawn based on historic behavior at the station and under current context (temperature, precipitation, time of day, etc.).

The image can also be used to identify which charging points are being used, even if all vehicles cannot be identified. This can be done on the presence of vehicles at certain locations in the image, even if their characteristics cannot be seen. These two elements can provide at least a partial snapshot of the usage. The process can further attempt to identify charging time remaining at 311, for any vehicles that can be seen but for whose SoC is unknown at 309. If the SoC is unknown, a mean or median charging time observed at the station and under the current context, which may be a good or bad estimate depending on how consistently different customers behave. If customer behavior is fairly clustered around a range, for example, such an estimate may still be more useful than not knowing any information at all.

For example, a vehicle may have (based on model) the capability to use a charging point for one hour, but it may also be observed that at this station and/or some other local stations within a predefined geographic proximity that, at this time of day, and/or within temporal proximity to this time of day (e.g., +/−30 minutes), people do not historically sit at stations for more than 20 minutes, more than 80 percent of the time. For example, during rush hour, people may simply want enough charge to get home so they can relax while their vehicle charges at home. So the estimate, in this example, could be a weighted average of 20%*60 minutes (full charge)+80%*20 minutes (common usage)=28 minutes expected usage. In other instances, if the system was being conservative, or if context data was lacking, the system may often or always assume that the observed vehicle will require a full charge. This observation can be modified by, for example, a later passing vehicle observing the same vehicle as being present—i.e., the second observed instance of the same vehicle will be assigned the remaining time based on the first observed instance and the assumption of a full charge, as opposed to resetting the observation for that particular vehicle and point combination.

The process then updates station data for the visible charging points at that station a 313, and can also update location data 315 to indicate where the useful image(s), from which the preceding information was derived, were captured, as well as what type of vehicle, heading, camera view, camera angle, etc. was used to capture the image(s).

FIG. 4A shows an illustrative reporting process. In this example, the vehicle begins charging at 401 and estimates remaining charge time to a target goal and/or a full charge at 403. The same information can be calculated by a charging point or station computer, if the vehicle SoC is known. In other instances, the driver may be on a schedule and may actually request the duration of the charge, in which case no estimate need be made unless the SoC is so high that the requested time is actually too much time. In still a further example, a driver may request a certain amount of energy—e.g., 100 miles of range or a measure of KwH, and in those instances the estimate can include how long it will likely take to provide that level of additional charge. Again, the SoC need not necessarily be known in order to calculate numbers related to the amount of time specifically requested or an express amount of power (or additional achievable mileage) requested. On the other hand, if certain charging speeds are only recommended for use between certain battery levels, the SoC may still be relevant to at least some of these calculations.

Once an expected duration of usage is known at 403, the vehicle (or station or charging point) can broadcast, via, for example ultra wide band (UWB) or BLUETOOTH low energy (BLE) broadcast the remaining charging time. This may be useful in a number of regards, allowing passing vehicles to recognize an upcoming charging opportunity as well as convey that information to the backend. This is also useful if the vehicle directly reports to a different OEM backend, this allows vehicles of other OEMs to collect this information on the other OEMs behalf, which benefits everyone. The broadcast may also include an identifier of the broadcasting vehicle (or vehicle on behalf of which broadcast is made) that allows people to know which space will open, and, in the context of cloud reporting with an accompanying image, would allow for backfilling information about which vehicle in the image to which the broadcast information applied.

Until the charging process finishes at 407, the vehicle 100 may update its respective backend OEM dataset at 409 and continue the broadcast. In this example, recalculation occurs as part of the loop in case variables change and charging time increases or decreases. Broadcast ceases at 411 when the charging completes.

Stations may want to broadcast this information for data sharing purposes, whether or not a given OEM wants to share the information with competitors, and so charging points and/or stations may also be capable of determining the information to calculate remaining charge time and sharing the information. In that instance, if the station cannot identify the vehicle to which the information pertains, the station may instead identify a space number, which, in the example of image processing, could be correlated to a given vehicle based on a knowledge of the numbering of spaces at the station and the location of the given vehicle in the image.

FIG. 4B shows an illustrative charging report reception and utilization process. In this example, when the vehicle receives the information from the broadcast at 421, the vehicle can update the cloud at 423, also appending any images if they are captured, useful and applicable.

Further, in this example, the vehicle 100 may determine if the vehicle has an immediate need for charging at 425. Need can be defined as more than a low power state, for example, and can include a long trip that will require multiple charge stops—if a point is available now, the user may want to take advantage even if an SoC is above 70%, for example. That diminishes a chance further down the road that charging will not be immediately available when needed, and provides greater latitude in selection of a next charging point.

If there is a conceivable reason why the driver may want power at 425 (which can include both baseline conditions set by an OEM—e.g., long journey requiring at least one recharge; as well as driver set conditions—e.g., any time power is below 50%), then the process will estimate, based on available information, a next available or multiple next available charging points at 427. Those can be points along a route, proximate points, etc., for which data is known sufficiently to make a reasonable estimate. The process then determines which option is faster at 429.

For example, if a current charge time broadcast indicated 10 minutes remaining, and the vehicle was on-site, the driver knows that the wait is 10 minutes. If an alternative was open, but 8 minutes off-route, that would involve 16 minutes of additional travel and thus would achieve a longer delay, in addition to any chance that the spot would be filled prior to arrival. If the present option is faster, the vehicle or backend may recommend a stop at 431, otherwise the process may simply inform the driver of the upcoming availability at 433, as well as one or more other options believed to be faster, but which may carry greater chances of not being available based on unforeseen variables.

In addition to being useful for charging point analysis, the concepts discussed herein about dynamic camera data gathering can be used more generally when real-time information about a situation is desired. Knowledge of what data is provided by what sight lines at what camera angles and positions can be used to instruct a variety of data gathering events. For example, it may be known that an overpass provides views of a highway or arena parking lot. Vehicles traveling on the overpass can image the relevant visible areas to obtain data about a situation occurring at the area in order to obtain a better understanding of the situation. Refinement of these images—e.g., which images reveal useful information, can be done in a manner comparable to that discussed with regards to charging stations, so that better images can be obtained more precisely with time.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system comprising:
one or more processors configured to:
receive an image identified as related to a charging location and including at least one viewpoint of the charging point;
analyze the image to determine if the charging point is currently in use based at least in part on the presence of a vehicle at the charging point in the image;
determine projected usage time of a charging point determined to be in use, based on at least one characteristic of the vehicle; and
update a usage set indicating real-time usage of the charging point based on the projected usage time.

2. The system of claim 1, wherein the charging point is determined to be in use based at least in part on a visible connection between the charging point and the vehicle.

3. The system of claim 1, wherein the charging point is determined to be in use based at least in part on an active charging indicator provided to an exterior of the vehicle and visible in the image.

4. The system of claim 1, wherein the at least one characteristic includes an active charging indicator provided to an exterior of the vehicle and visible in the image and wherein the projected usage time is based at least in part on current state of charge as indicated by the active charging indicator.

5. The system of claim 1, wherein the at least one characteristic includes a model of the vehicle and wherein the projected usage time is based at least in part on a known charging time for the vehicle based on battery capacity for the vehicle identifiable from the model.

6. The system of claim 1, wherein the projected usage time is adjusted based at least in part on observed historical durations of charging times observed for the charging point or at least one other charging point within a predefined proximity to the charging point.

7. The system of claim 6, wherein the historical durations of charging times used in adjusting the projected usage time are selected based on having observed times-of-day within a predefined temporal proximity to a current time.

8. A vehicle comprising:
one or more processors configured to:
determine that a current vehicle location corresponds to a predefined image capture location included in an image capture request;
determine that the vehicle includes at least one camera having a field-of-view encompassing directionally for imaging identified in the image capture request;
responsive to both the current vehicle location corresponding to the image capture location and the vehicle including the at least one camera, automatically capturing an image using the at least one camera; and
automatically sending the image to a backend that issued the image capture request.

9. The vehicle of claim 8, wherein the image capture location includes an area defined by a geo-fence.

10. The vehicle of claim 9, wherein the vehicle location corresponds to the image capture location based on the vehicle being located within the geofence.

11. The vehicle of claim 8, wherein the one or more processors are further configured to:
analyze the image to confirm that at least one charging point appears in the image, prior to sending the image to the backend responsive to the confirmation.

12. The vehicle of claim 11, wherein, responsive to the analysis not providing confirmation that the at least one charging point appears in the image, automatically capturing an additional image using the at least one camera and repeating the analysis.

13. The vehicle of claim 8, wherein the predefined image capture location includes a geographic proximity around a known charging point location, both the proximity and charging point location identified in the image capture request.

14. The vehicle of claim 8, wherein the determination that the vehicle includes the at least one camera having the field-of-view encompassing directionally for imaging is based at least in part on a vehicle heading.

15. A method comprising:
receiving at least one image from a vehicle that captured the image, the image sent as indicative of a current use status of a charging point and including a location of the vehicle when the image was captured;
analyzing the image to determine whether there is at least one visual impediment present in the image; and
responsive to determining a visual impediment is present, both updating the location as an obstructed location in a dataset and updating an image capture request to one or more other vehicles to remove the location from a set of locations at which image capture is requested.

16. The method of claim 15, wherein the method further includes:
determining whether the visual impediment is temporary or permanent based on one or more characteristics of the visual impediment, and wherein the updating the location and the updating the image capture request are both further responsive to the visual impediment being permanent.

17. The method of claim 16, wherein a temporary visual impediment includes at least one of a passing vehicle, identifiable by at least one vehicle characteristic shown in the image or at weather-related obfuscation of view, identifiable based at least in part on known weather at the location.

18. The method of claim 16, wherein a permanent visual impediment includes at least one of a sign, identifiable by at least one sign characteristic shown in the image or flora, identifiable by at least one flora characteristic shown in the image.

19. The method of claim 15, wherein the image includes at least a model of the vehicle and a heading of the vehicle and wherein the updating the location and the updating the image capture request further includes identification of a camera of the vehicle capturing the image, based at least in part on the model and the heading, and wherein the updating of the location as obstructed includes identification of obstruction as relative to field-of-view for the identified camera and based on the heading, and the one or more vehicles updated with the image capture request to remove the location are chosen based on the one or more vehicles having cameras with substantially similar fields of view.

20. The method of claim 15, wherein the image includes at least a heading of the vehicle and wherein the updating of the location as obstructed includes identification of obstruction as relative to the heading, and the updating the image capture request to remove the location includes the heading as a restriction on removal of the location to limit the removal to instances when the one or more other vehicles have substantially similar headings.
